(19) United States
(12) Patent Application Publication
(10) Pub. No.: US 2018/0183845 A1
(43) Pub. Date: Jun. 28, 2018

(54) SYSTEMS AND METHODS FOR PROVIDING CONTENT

(71) Applicant: Facebook, Inc., Menlo Park, CA (US)

(72) Inventors: Michael Hamilton Coward, Solana Beach, CA (US); Amit Puntambekar, Fremont, CA (US)

(21) Appl. No.: 15/388,477

(22) Filed: Dec. 22, 2016

(51) Int. Cl. H04L 29/06

(52) U.S. Cl. CPC H04L 65/4092; H04L 65/601

(57) ABSTRACT

Systems, methods, and non-transitory computer-readable media can determine that a content item is being accessed by a computing device, the content item being associated with a set of streams that are each encoded at a different bit rate, each stream in the set of streams having been partitioned into at least a first set of segments and a second set of segments that span the entirety of the stream. A segment from a first set of segments of a first stream in the set of streams is provided to the computing device. One or more segments from a second set of segments of the first stream are provided to the computing device.

### FIELD OF THE INVENTION

The present technology relates to the field of content provision. More particularly, the present technology relates to techniques for providing content through computing devices.

### BACKGROUND

Today, people often utilize computing devices (or systems) for a wide variety of purposes. Users can operate their computing devices to, for example, interact with one another, create content, share content, and access information. Under conventional approaches, content items (e.g., images, videos, audio files, etc.) can be made available through a content sharing platform. Users can operate their computing devices to access the content items through the platform. Typically, the content items can be provided, or uploaded, by various entities including, for example, content publishers and also users of the content sharing platform. In some instances, the content items can be categorized and/or curated.

### SUMMARY

Various embodiments of the present disclosure can include systems, methods, and non-transitory computer readable media configured to determine that a content item is being accessed by a computing device, the content item being associated with a set of streams that are each encoded at a different bit rate, each stream in the set of streams having been partitioned into at least a first set of segments and a second set of segments that span the entirety of the stream. A segment from a first set of segments of a first stream in the set of streams is provided to the computing device. One or more segments from a second set of segments of the first stream are provided to the computing device.

In some embodiments, the first set of segments of the first stream each include at least one inter frame corresponding to the content item.

In some embodiments, the second set of segments of the first stream each include at least one predictive frame corresponding to the content item.

In some embodiments, the systems, methods, and non-transitory computer readable media are configured to determine that the computing device has requested a second stream in the set of streams, the second stream having a different bit rate than the first stream and provide a segment from a first set of segments of the second stream to the computing device.

In some embodiments, the systems, methods, and non-transitory computer readable media are configured to determine that the computing device has again requested the second stream and provide one or more segments from a second set of segments of the second stream to the computing device.

In some embodiments, the systems, methods, and non-transitory computer readable media are configured to determine that the computing device has requested a third stream in the set of streams, the third stream having a different bit rate than the second stream and provide a segment from a first set of segments of the third stream to the computing device.

In some embodiments, the systems, methods, and non-transitory computer readable media are configured to determine that the computing device has again requested the third stream and provide one or more segments from a second set of segments of the third stream to the computing device.

In some embodiments, each segment corresponds to some pre-defined portion of the first stream.

In some embodiments, each segment in the first set of segments that corresponds to a portion of the first stream has an analogue segment in the second set of segments that also corresponds to the same portion of the first stream.

In some embodiments, each stream in the set of streams can be streamed to playback the content item in its entirety.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content provider module, according to an embodiment of the present disclosure.

FIG. 2 illustrates an example of a stream encoding module, according to an embodiment of the present disclosure.

FIG. 3 illustrates an example of a client module, according to an embodiment of the present disclosure.

FIGS. 4A-B illustrate examples of streaming of a content item, according to an embodiment of the present disclosure.

FIG. 5 illustrates an example method, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Providing Content

People use computing devices (or systems) for a wide variety of purposes. A user can operate a computing device to stream content items (e.g., audio and/or video data) over a network (e.g., Internet). Streaming a content item typically involves delivering data corresponding to the content item over a network from a content provider to a computing device. As the content item is being streamed (or downloaded), a software application (e.g., content player) running on the computing device can be used to decode and present the content item, for example, through a display screen of the computing device and/or by playing audio content corresponding to the content item.

Under conventional approaches, a content item may be accessed using multiple streams that each have a different bit rate (e.g., a high quality stream, medium quality stream, low quality stream, etc.). Each stream can be partitioned into segments that each correspond to some portion of the stream (e.g., 1-second segments, 2-second segments, 10-second segments, etc.). A computing device that requests streaming of the content item can be made aware of the multiple streams that are available for streaming the content item. Initially, the computing device may request streaming of segments from a medium quality stream corresponding to the content item. While accessing the medium quality stream, if the computing device determines that there is enough bandwidth (or download speed) to stream content at a higher quality, then the computing device can request subsequent segments from a higher quality stream corresponding to the content item. Similarly, if the computing device determines that there is not enough bandwidth to stream content at medium quality, then the computing device can request segments from a lower quality stream corresponding to the content item. In some instances, there may be an added cost when switching between different quality streams corresponding to a content item. Such costs can degrade the overall user experience. Accordingly, such conventional approaches may not be effective in addressing these and other problems arising in computer technology.

An improved approach rooted in computer technology overcomes the foregoing and other disadvantages associated with conventional approaches specifically arising in the realm of computer technology. In various embodiments, multiple streams can be generated for a content item. Each stream can be used to playback the entirety of the content item. In such embodiments, each stream can be encoded at a different bit rate (e.g., a high quality stream, medium quality stream, low quality stream, etc.). Further, each stream can be partitioned into a first set of segments that each correspond to some portion of the stream (e.g., 1-second segments, 2-second segments, 10-second segments, etc.). In some embodiments, each segment in the first set of segments is encoded to include at least one inter frame (e.g., I-frame). Similarly, each stream can also be partitioned into a second set of segments that each also correspond to some portion of the stream. In some embodiments, segments in the second set of segments are encoded as predicted frames (e.g., P-frames, B-frames, etc.).

A computing device accessing the content item may initially request a medium quality stream corresponding to the content item. When accessing the medium quality stream, the computing device can obtain and present at least one initial key frame segment (e.g., inter frame segment) corresponding to the medium quality stream. In some embodiments, this initial key frame segment may be included in a first set of segments (e.g., inter frame segments) corresponding to the medium quality stream. As playback continues, the computing device can continue presenting segments from a second set of segments (e.g., P-frames, B-frames, etc.) corresponding to the medium quality stream. In this example, if the computing device determines that there is not enough bandwidth to stream the medium quality stream, the computing device can request segments from a lower quality stream corresponding to the content item. In some embodiments, when switching to a different quality stream, the computing device obtains and presents at least one segment from a first set of segments (e.g., inter frame segments) corresponding to the different quality stream. Subsequently, the computing device can continue streaming the content item using segments from a second set of segments (e.g., P-frames, B-frames, etc.) corresponding to the different quality stream.

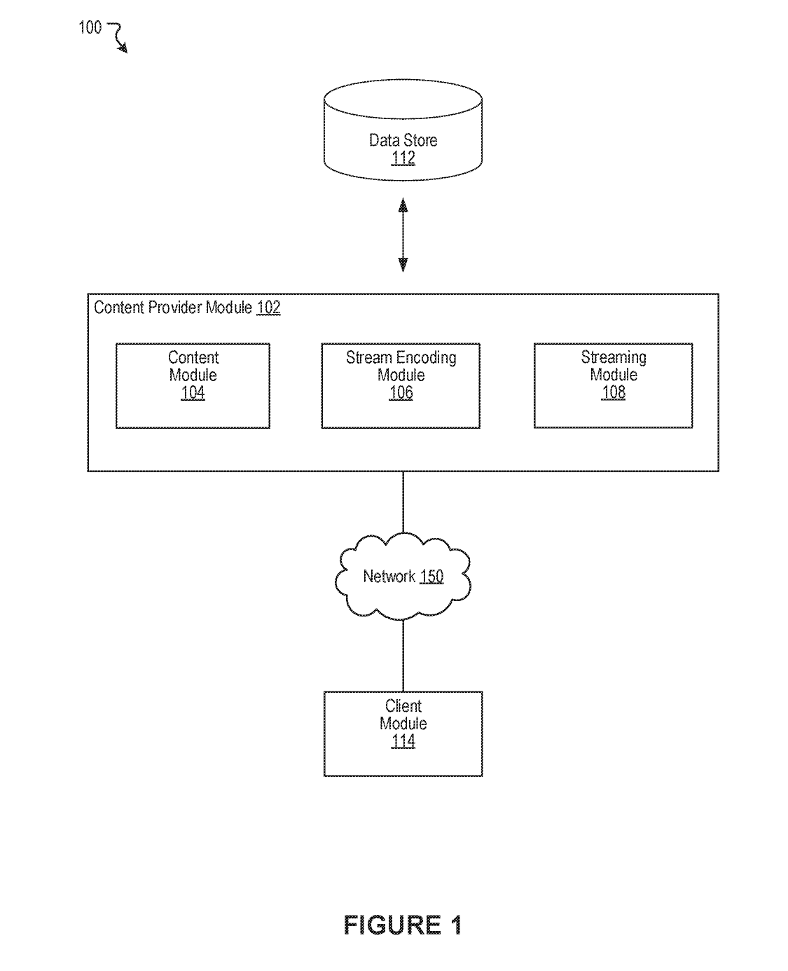

FIG. 1 illustrates an example system 100 including an example content provider module 102, according to an embodiment of the present disclosure. As shown in the example of FIG. 1, the content provider module 102 can include a content module 104, a stream encoding module 106, and a streaming module 108. In some instances, the example system 100 can include at least one data store 112. A client module 114 can interact with the content provider module 102 over one or more networks 150 (e.g., the Internet, a local area network, etc.). The client module 114 can be implemented in a software application running on a computing device. In various embodiments, the network 150 can be any wired or wireless computer network through which devices can exchange data. For example, the network 150 can be a personal area network, a local area network, or a wide area network, to name some examples. The components (e.g., modules, elements, etc.) shown in this figure and all figures herein are exemplary only, and other implementations may include additional, fewer, integrated, or different components. Some components may not be shown so as not to obscure relevant details.

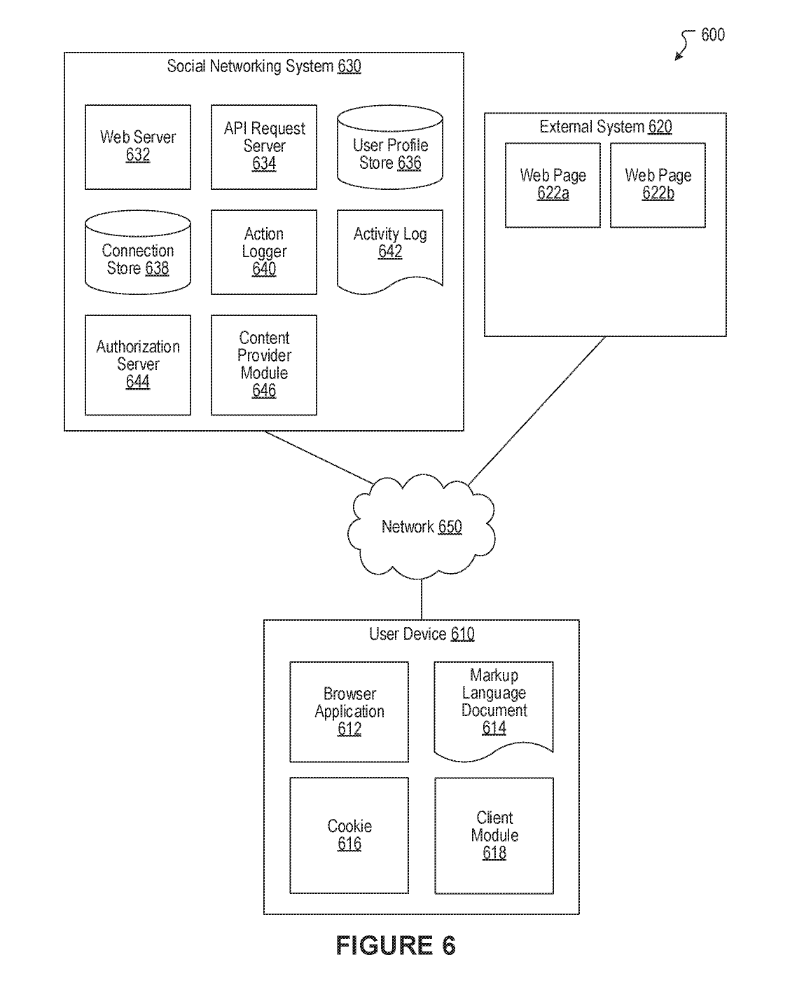

In some embodiments, the content provider module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the content provider module 102 can be implemented, in part or in whole, as software running on one or more computing devices or systems, such as on a user computing device or client computing system. For example, the content provider module 102, or at least a portion thereof, can be implemented as or within an application (e.g., app), a program, or an applet, etc., running on a user computing device or a client computing system, such as the user device 610 of FIG. 6. Further, the content provider module 102, or at least a portion thereof, can be implemented using one or more computing devices or systems that include one or more servers, such as network servers or cloud servers. In some instances, the content provider module 102 can, in part or in whole, be implemented within or configured to operate in conjunction with a social networking system (or service), such as the social networking system 630 of FIG. 6. It should be understood that there can be many variations or other possibilities.

In some embodiments, the content provider module 102 can be configured to communicate and/or operate with the at least one data store 112 in the example system 100. The at least one data store 112 can be configured to store and maintain various types of data. In various embodiments, the at least one data store 112 can store data relevant to function and operation of the content provider module 102. One example of such data can be content items that are available for access (e.g., streaming). In some implementations, the at least one data store 112 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 112 can store information associated with users, such as user identifiers, user information, profile information, user specified settings, content produced or posted by users, and various other types of user data. It should be appreciated that there can be many variations or other possibilities.

In various embodiments, the content module 104 can provide access to various types of content items to be presented through an interface. This interface may be provided through a display of a computing device in which the client module 114 is implemented, for example. In some instances, the computing device may be running a software application (e.g., social networking application) that is configured to present content items. In some embodiments, these content items can include virtual reality content items (e.g., videos composed using monoscopic 360 degree views, videos composed using stereoscopic 180 degree views, spherical videos, etc.). In some embodiments, a spherical video can capture 360 degree views of one or more scenes over some duration of time. Such scenes may be captured from the real world and/or be computer generated. Further, the spherical video can be created by stitching together various video streams (or feeds) that were captured by cameras that are placed at different locations and/or positions to capture a 360 degree view of the scene. Such streams may be pre-determined for various directions, e.g., angles (e.g., 0 degree, 30 degrees, 60 degrees, etc.), accessible in a spherical video. In some embodiments, multiple streams having different bit rates (e.g., high quality stream, medium quality stream, low quality stream, etc.) can be generated for each of these spherical video streams using the approaches described herein. Once stitched together, a user can access, or playback, the spherical video to view a portion of the spherical video along some direction (or angle). Generally, the portion of the spherical video (e.g., stream) shown to the user can be determined based on the location and direction of the user's viewport in three-dimensional space. The approaches described herein can be implemented to allow the user's computing device to switch between the different quality levels of a given stream.

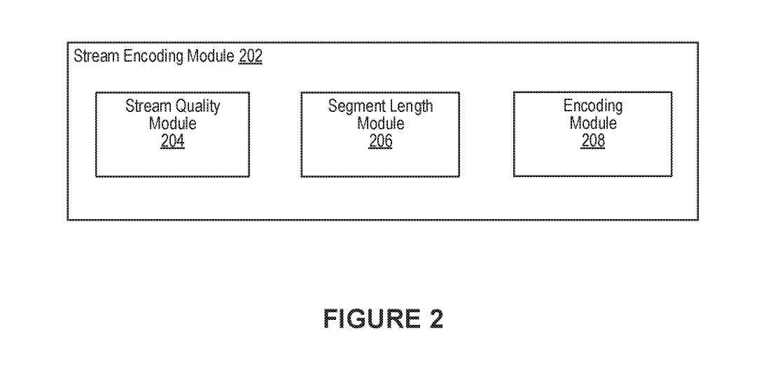

In some embodiments, the stream encoding module 106 can generate respective streams for content items at various bit rates (e.g., high quality streams, medium quality streams, low quality streams, etc.). More details describing the stream encoding module 106 will be provided below in reference to FIG. 2.

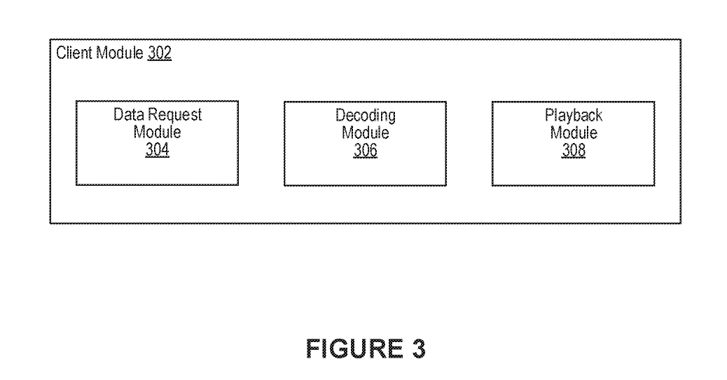

The streaming module 108 can be configured to send, or transmit, data corresponding to portions of any content item that is requested, for example, by the client module 114. The streaming module 108 can utilize generally known approaches and protocols for streaming content including, for example, the HyperText Transfer Protocol (HTTP) or the Real-time Streaming Protocol (RTSP), to name some examples. The client module 114 can present the content received from the streaming module 108. More details describing the client module 114 will be provided below in reference to FIG. 3.

FIG. 2 illustrates an example of a stream encoding module 202, according to an embodiment of the present disclosure. In some embodiments, the stream encoding module 106 of FIG. 1 can be implemented with the stream encoding module 202. As shown in the example of FIG. 2, the stream encoding module 202 can include a stream quality module 204, a segment length module 206, and an encoding module 208.

In various embodiments, the stream quality module 204 can be utilized to define (or specify) respective quality levels, or bit rates, for a set of streams to be generated for a content item. For example, a content item may have a first stream that corresponds to a first quality level, a second stream that corresponds to a second quality level, and a third stream that corresponds to a third quality level. In some instances, different content items may each have a different number of quality streams. In some embodiments, the number of quality streams to be generated for a content item is pre-defined. In one example, each content item may have a first stream at a first quality level and a second stream at a second quality level. Naturally, additional streams at various quality levels may also be generated for a given content item. In some embodiments, the respective quality levels (or bit rates) of each of these streams are also pre-defined.

As mentioned, a stream (or quality stream) can be partitioned into segments that each correspond to some portion of the stream (e.g., 1-second segments, 2-second segments, 10-second segments, etc.). In some embodiments, the segment length module 206 can be utilized to define (or specify) segment lengths for streams corresponding to content items. In one example, streams corresponding to a first content item can each be partitioned into 1-second segments. In some instances, streams corresponding to different content items may be partitioned into segments of different lengths. For example, the streams of a first content item may be partitioned into 1-second segments while the streams of a second content item can be partitioned into 5-second segments. In some embodiments, the segment length to be used when partitioning streams of content items is pre-defined.

The encoding module 208 can be configured to encode content data into some digital format that can be presented by a software application (e.g., social networking application, content player, etc.). In general, the encoding module 208 can be configured to encode video content using generally known video codecs, such as the H.264 or MPEG-4 video formats. Further, the encoding module 208 can be configured to encode audio content using generally known audio codecs, such as the MPEG-1 or MPEG-2 Audio Layer III (MP3) audio formats. In some embodiments, when encoding a content item, the encoding module 208 generates multiple streams for the content item with each stream having a different bit rate (or quality level). For example, for a given content item, the encoding module 208 can generate a first stream at a first bit rate, a second stream at a second bit rate, and a third stream at a third bit rate. In general, each stream can be used to playback the entirety of the content item at its respective bit rate. The respective bit rates (or quality levels) used to encode the different streams can be determined by the stream quality module 204.

The encoding module 208 can also partition each of the different streams into segments. In some embodiments, each stream is partitioned into a first set of segments that each correspond to some portion of the stream (e.g., 1-second segments, 2-second segments, 10-second segments, etc.). In such embodiments, each segment in the first set of segments is encoded to include at least one inter frame (e.g., I-frame). Similarly, each stream can also be partitioned into a second set of segments that each also correspond to some portion of the stream. In some embodiments, each segment in the second set of segments is encoded as a predicted frame (e.g., P-frames, B-frames, etc.). That is, in such embodiments, segments in the second set of segments are not encoded to include any inter frames. In some embodiments, every segment in the first set of segments has an analogue segment in the second set of segments. In other words, a segment in the first set of segments that corresponds to a portion of the stream will have an analogue segment in the second set of segments that also corresponds to the same portion of the stream. For example, a segment in a first set of segments corresponding to some interval of time (e.g., seconds 0 to 10) in a stream can have an analogue segment in a second set of segments of the stream that also corresponds to the same interval of time (e.g., seconds 0 to 10). The length, or size, of the segments generated by the encoding module 208 can be determined by the segment length module 206.

FIG. 3 illustrates an example client module 302, according to an embodiment of the present disclosure. In some embodiments, the client module 114 of FIG. 1 can be implemented with the client module 302. As shown in the example of FIG. 3, the client module 302 can include a data request module 304, a decoding module 306, and a playback module 308. In some embodiments, the client module 302 is implemented in a computing device (e.g., the user device 610 of FIG. 6).

In some embodiments, the data request module 304 can be configured to obtain data corresponding to content items being streamed from a content provider. For example, when accessing a content item, the data request module 304 can request a stream corresponding to the content item. In this example, the data request module 304 can initially request a medium quality stream corresponding to the content item. In some embodiments, the content provider sends the client module 302 at least one initial key frame segment (e.g., inter frame segment) corresponding to the medium quality stream. In some embodiments, this initial key frame segment may be included in a first set of segments (e.g., inter frame segments) corresponding to the medium quality stream. As playback continues, the data request module 304 can obtain additional segments from a second set of segments (e.g., P-frames, B-frames, etc.) corresponding to the medium quality stream.

In various embodiments, the data request module 304 can be configured to modify, or adjust, the stream being used to access the content item based on the amount of bandwidth that is available. For example, the computing device in which the client module 302 is implemented can access a content item for which multiple streams have been generated at different quality levels (or bit rates). In this example, the computing device may initially request a medium quality stream. When accessing the medium quality stream, the computing device can obtain and present at least one initial key frame segment from a first set of segments (e.g., inter frame segments) corresponding to the medium quality stream. As playback continues, the computing device can continue presenting segments from a second set of segments (e.g., P-frames, B-frames, etc.) corresponding to the medium quality stream. In this example, if the computing device determines that there is not enough bandwidth to stream the medium quality stream, the computing device can request segments from a lower quality stream corresponding to the content item. In some embodiments, when switching to a different quality stream (e.g., the lower quality stream), the computing device obtains and presents at least one segment from a first set of segments (e.g., inter frame segments) corresponding to the different quality stream. Once the segment from the first set of segments has been presented, the computing device can continue streaming the content item using segments from a second set of segments (e.g., P-frames, B-frames, etc.) corresponding to the different quality stream (e.g., the lower quality stream). At some point during the playback, the computing device may determine that there is enough bandwidth to stream the content item using a high quality stream. In this example, the computing device can obtain and present at least one segment from a first set of segments (e.g., inter frame segments) of the high quality stream corresponding to the content item. As playback continues, the computing device can continue presenting segments from a second set of segments (e.g., P-frames, B-frames, etc.) corresponding to the high quality stream. In some embodiments, this switching between the different quality streams corresponding to the content item can continue periodically (e.g., at specified time intervals) as the content item is streamed.

As mentioned, the data request module 304 can determine the amount of bandwidth available to the client module 302. In some embodiments, the data request module 304 determines the amount of bandwidth available by determining a running rate (e.g., bits per second) of a stream. This running rate can be computed by dividing the amount of data (e.g., number of bits) corresponding to the stream that has already been received by the duration of time over which the content has been streamed. Thus, for example, if 500 kilobits of a stream has been received over a duration of five seconds, then the running rate is 100 kilobits per second. Depending on the implementation, the data request module 304 can be configured to periodically determine the running rate of a stream at specified time intervals and/or when a call, or instruction, is received from the client module 302. The data request module 304 can also be configured to determine a source rate at which the stream was encoded. In some instances, the data request module 304 may receive (or obtain) information describing the source rate for the stream from the content provider. In various embodiments, the running rate can be evaluated with respect to the source rate to gauge the amount of bandwidth that is available to the computing device.

The decoding module 306 can be configured to decode the received content data (e.g., segments) so that encoded content can be presented through a display screen of the computing device. As mentioned, content data can be encoded before being sent or transmitted. Once content data is received by the client module 302, the decoding module 306 can decode the content data, for example, by determining the format, or codec, used to encode the content data and using that information to decode the content data. The decoding process can be performed as the content data is being streamed to the client module 302.

The playback module 308 can be configured to present the decoded content as the content is received. For example, the playback module 308 can be configured to play video content through the display screen of the computing device. The playback module 308 can also be configured to play audio content through an audio output source of the computing device.

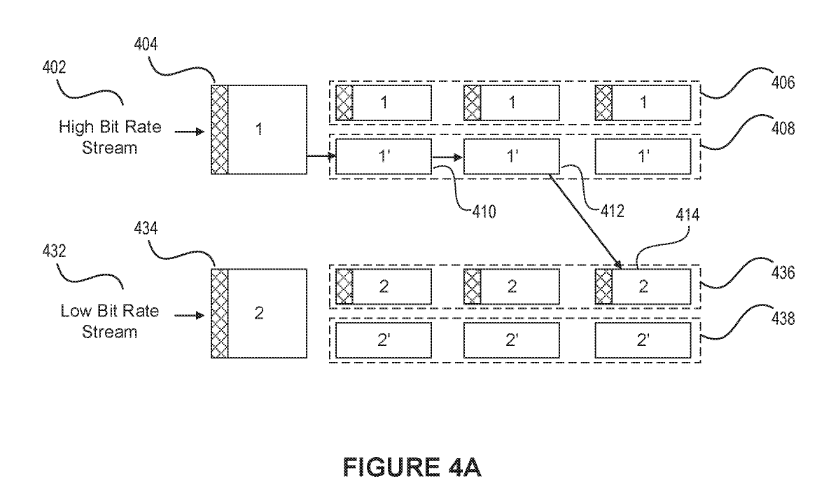

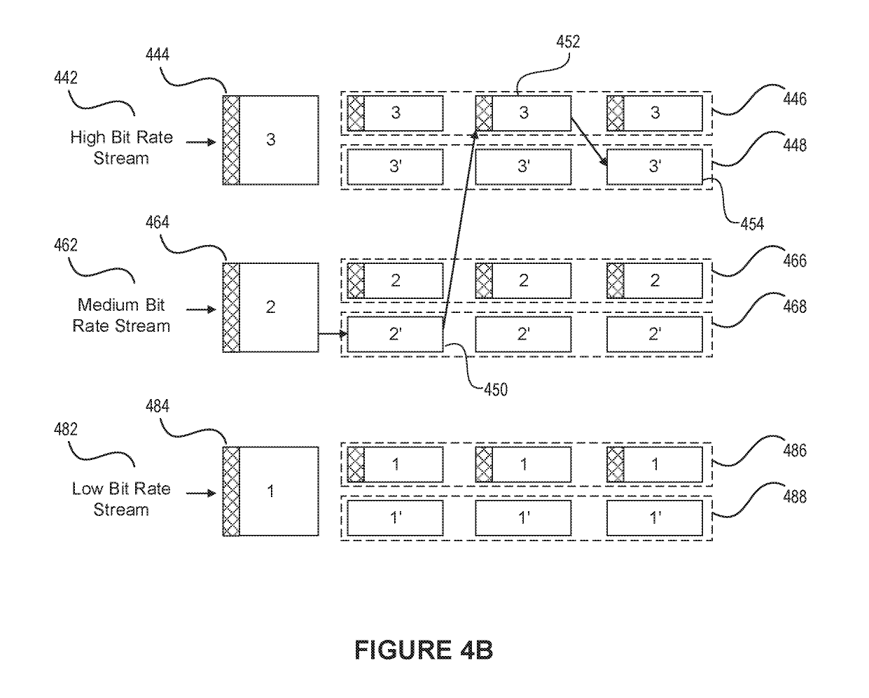

FIGS. 4A-B illustrate examples of streaming of a content item, according to an embodiment of the present disclosure. FIG. 4A illustrates an initial key frame segment 404 corresponding to a first stream 402 of the content item which was encoded at a first bit rate (e.g., high quality bit rate). In some embodiments, this initial key frame segment 404 may be included in a first set of segments 406 corresponding to the first stream 402. In this example, each segment in the first set of segments 406 was encoded to include at least one inter frame (e.g., I-frame). The first stream 402 also includes a second set of segments 408. In this example, each segment in the second set of segments 408 was encoded using predictive frames (e.g., P-frames, B-frames, etc.). FIG. 4A also illustrates a second stream 432 of the content item that was encoded at a second bit rate (e.g., low quality bit rate). The second stream 432 is associated with its own initial key frame segment 434. In some embodiments, this initial key frame segment 434 may be included in a first set of segments 436 corresponding to the second stream 432. In this example, the second stream 432 also includes a second set of segments 438. Like the first stream 402, each of the first set of segments 436 of the second stream 432 were encoded to include at least one inter frame (e.g., I-frame). Similarly, each of the second set of segments 438 of the second stream 432 were encoded as predictive frames (e.g., P-frames, B-frames, etc.).

In this example, a computing device accessing the content item can initially request the first stream 402, which was encoded at a high quality bit rate, from a content provider. The content provider can send the initial key frame segment 404 corresponding to the first stream 402 to the computing device. The computing device can process and present the segment 404. During this time, the computing device can determine whether enough bandwidth is available to continue streaming the content item at the high quality bit rate. In this example, the computing device determines that enough bandwidth is available and, therefore, requests additional segments from the first stream 402. In response, the content provider sends a segment 410 from the second set of segments 408 corresponding to the first stream 402. As mentioned, segments in the second set of segments 408 were encoded using predictive frames and, therefore, are compressed at a higher rate than segments in the first set of segments 406. Again, the computing device determines that enough bandwidth is available and, therefore, requests additional segments from the first stream 402. In response, the content provider sends a segment 412 from the second set of segments 408 corresponding to the first stream 402. After receiving the segment 412, the computing device may determine that there is insufficient bandwidth to continue streaming the content item at the higher quality bit rate. As a result, the computing device can request the second stream 432 that was encoded at a lower quality bit rate. As mentioned, in some embodiments, when switching to a different quality stream, the computing device obtains and presents at least one segment from a first set of segments (e.g., inter frame segments) corresponding to the different quality stream. In such embodiments, the computing device can continue streaming the content item using segments from a second set of segments (e.g., P-frames, B-frames, etc.) corresponding to the different quality stream. Thus, in this example, the content provider sends the next segment from the second stream 432. That is, the content provider sends the segment 414 from the first set of segments 436 of the second stream 432. As playback continues, the computing device can obtain additional segments from the second set of segments 438 to continue streaming the content item using the second stream 432.

Naturally, there may be additional streams that are generated for content items. For example, FIG. 4B illustrates an initial key frame segment 444 corresponding to a first stream 442 of a content item that was encoded at a first bit rate (e.g., high quality bit rate). In some embodiments, this initial key frame segment 444 may be included in a first set of segments 446 corresponding to the first stream 442. In this example, each segment in the first set of segments 446 was encoded to include at least one inter frame (e.g., I-frame). The first stream 442 also includes a second set of segments 448. In this example, each segment in the second set of segments 448 was encoded using predictive frames (e.g., P-frames, B-frames, etc.). FIG. 4B also illustrates a second stream 462 of the content item that was encoded at a second bit rate (e.g., medium quality bit rate). The second stream 462 is associated with its own initial key frame segment 464. In some embodiments, this initial key frame segment 464 may be included in a first set of segments 466 corresponding to the second stream 462. In this example, the second stream 462 also includes a second set of segments 468. Like the first stream 442, each of the first set of segments 466 of the second stream 462 were encoded to include at least one inter frame (e.g., I-frame). Similarly, each of the second set of segments 468 of the second stream 462 were encoded as predictive frames (e.g., P-frames, B-frames, etc.). FIG. 4B also illustrates a third stream 482 of the content item that was encoded at a third bit rate (e.g., low quality bit rate). The third stream 482 is associated with its own initial key frame segment 484. In some embodiments, this initial key frame segment 484 may be included in a first set of segments 486 corresponding to the third stream 482. In this example, the third stream 482 also includes a second set of segments 488. Like the first stream 442, each of the first set of segments 486 of the third stream 482 were encoded to include at least one inter frame (e.g., I-frame). Similarly, each of the second set of segments 488 of the third stream 482 were encoded as predictive frames (e.g., P-frames, B-frames, etc.).

In this example, a computing device accessing the content item can initially request the second stream 462 which was encoded at a medium quality bit rate from a content provider. The content provider can send the initial key frame segment 464 corresponding to the second stream 462 to the computing device. The computing device can process and present the segment 464. During this time, the computing device can determine whether enough bandwidth is available to continue streaming the content item at the medium quality bit rate. In this example, the computing device determines that enough bandwidth is available and, therefore, requests additional segments from the second stream 462. In response, the content provider sends a segment 450 from the second set of segments 468 corresponding to the second stream 462. As mentioned, segments in the second set of segments 468 were encoded as predictive frames and, therefore, are compressed at a higher rate than segments in the first set of segments 466. After receiving the segment 450, the computing device may determine that there is sufficient bandwidth to stream the content item at the higher quality bit rate. As a result, the computing device can request the first stream 442 that was encoded at the high quality bit rate. As mentioned, in some embodiments, when switching to a different quality stream, the computing device obtains and presents at least one segment from a first set of segments (e.g., inter frame segments) corresponding to the different quality stream. In such embodiments, the computing device can continue streaming the content item using segments from a second set of segments (e.g., P-frames, B-frames, etc.) corresponding to the different quality stream. Thus, in this example, the content provider sends the next segment from the first stream 442. That is, the content provider provides the segment 452 from the first set of segments 446 of the first stream 442. As playback continues, the computing device can determine that enough bandwidth is available to continue streaming the first stream 442. As a result, the computing device can request additional segments from the first stream 442. In response, the content provider sends a segment 454 from the second set of segments 448 corresponding to the first stream 442. This process of switching between the different streams of the content item can continue for the remainder of the content item.

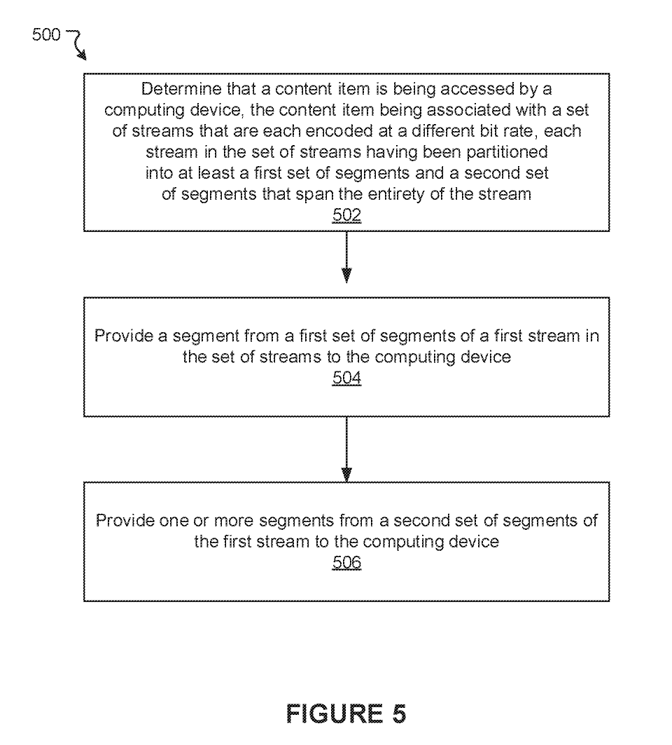

FIG. 5 illustrates an example method 500, according to an embodiment of the present disclosure. It should be appreciated that there can be additional, fewer, or alternative steps performed in similar or alternative orders, or in parallel, within the scope of the various embodiments discussed herein unless otherwise stated.

At block 502, a determination is made that a content item is being accessed by a computing device, the content item being associated with a set of streams that are each encoded at a different bit rate, each stream in the set of streams having been partitioned into at least a first set of segments and a second set of segments that span the entirety of the stream. At block 504, a segment from a first set of segments of a first stream in the set of streams is provided to the computing device. At block 506, one or more segments from a second set of segments of the first stream are provided to the computing device.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content provider module 646. The content provider module 646 can, for example, be implemented as the content provider module 102 of FIG. 1. In some embodiments, the content provider module 646, or some of its features, can be implemented in a computing device, e.g., the user device 610. In some embodiments, the user device 610 can include a client module 618. The client module 618 can, for example, be implemented as the client module 114 of FIG. 1. As discussed previously, it should be appreciated that there can be many variations or other possibilities.

### Hardware Implementation

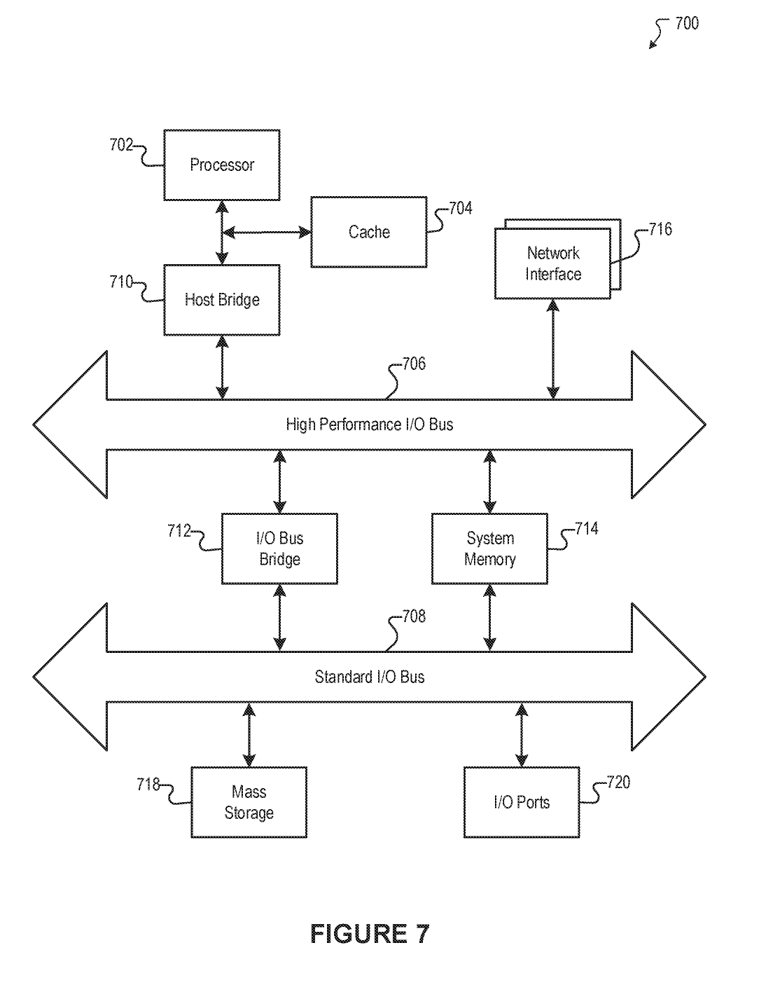

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, that a content item is being accessed by a computing device, the content item being associated with a set of streams that are each encoded at a different bit rate, each stream in the set of streams having been partitioned into at least a first set of segments and a second set of segments that span the entirety of the stream;
providing, by the computing system, a segment from a first set of segments of a first stream in the set of streams to the computing device; and
providing, by the computing system, one or more segments from a second set of segments of the first stream to the computing device.

2. The computer-implemented method of claim 1, wherein the first set of segments of the first stream each include at least one inter frame corresponding to the content item.

3. The computer-implemented method of claim 1, wherein the second set of segments of the first stream each include at least one predictive frame corresponding to the content item.

4. The computer-implemented method of claim 1, the method further comprising:
determining, by the computing system, that the computing device has requested a second stream in the set of streams, the second stream having a different bit rate than the first stream; and
providing, by the computing system, a segment from a first set of segments of the second stream to the computing device.

5. The computer-implemented method of claim 4, the method further comprising:
determining, by the computing system, that the computing device has again requested the second stream; and
providing, by the computing system, one or more segments from a second set of segments of the second stream to the computing device.

6. The computer-implemented method of claim 4, the method further comprising:
determining, by the computing system, that the computing device has requested a third stream in the set of streams, the third stream having a different bit rate than the second stream; and
providing, by the computing system, a segment from a first set of segments of the third stream to the computing device.

7. The computer-implemented method of claim 6, the method further comprising:
determining, by the computing system, that the computing device has again requested the third stream; and
providing, by the computing system, one or more segments from a second set of segments of the third stream to the computing device.

8. The computer-implemented method of claim 1, wherein each segment corresponds to some pre-defined portion of the first stream.

9. The computer-implemented method of claim 1, wherein each segment in the first set of segments that corresponds to a portion of the first stream has an analogue segment in the second set of segments that also corresponds to the same portion of the first stream.

10. The computer-implemented method of claim 1, wherein each stream in the set of streams can be streamed to playback the content item in its entirety.

11. A system comprising:
at least one processor; and
a memory storing instructions that, when executed by the at least one processor, cause the system to perform:
determining that a content item is being accessed by a computing device, the content item being associated with a set of streams that are each encoded at a different bit rate, each stream in the set of streams having been partitioned into at least a first set of segments and a second set of segments that span the entirety of the stream;
providing a segment from a first set of segments of a first stream in the set of streams to the computing device; and
providing one or more segments from a second set of segments of the first stream to the computing device.

12. The system of claim 11, wherein the first set of segments of the first stream each include at least one inter frame corresponding to the content item.

13. The system of claim 11, wherein the second set of segments of the first stream each include at least one predictive frame corresponding to the content item.

14. The system of claim 11, wherein the instructions further cause the system to perform:
determining that the computing device has requested a second stream in the set of streams, the second stream having a different bit rate than the first stream; and
providing a segment from a first set of segments of the second stream to the computing device.

15. The system of claim 14, wherein the instructions further cause the system to perform:
determining that the computing device has again requested the second stream; and
providing one or more segments from a second set of segments of the second stream to the computing device.

16. A non-transitory computer-readable storage medium including instructions that, when executed by at least one processor of a computing system, cause the computing system to perform a method comprising:
determining that a content item is being accessed by a computing device, the content item being associated with a set of streams that are each encoded at a different bit rate, each stream in the set of streams having been partitioned into at least a first set of segments and a second set of segments that span the entirety of the stream;
providing a segment from a first set of segments of a first stream in the set of streams to the computing device; and
providing one or more segments from a second set of segments of the first stream to the computing device.

17. The non-transitory computer-readable storage medium of claim 16, wherein the first set of segments of the first stream each include at least one inter frame corresponding to the content item.

18. The non-transitory computer-readable storage medium of claim 16, wherein the second set of segments of the first stream each include at least one predictive frame corresponding to the content item.

19. The non-transitory computer-readable storage medium of claim 16, wherein the instructions further cause the computing system to perform:
determining that the computing device has requested a second stream in the set of streams, the second stream having a different bit rate than the first stream; and
providing a segment from a first set of segments of the second stream to the computing device.

20. The non-transitory computer-readable storage medium of claim 16, wherein the instructions further cause the computing system to perform:
determining that the computing device has again requested the second stream; and
providing one or more segments from a second set of segments of the second stream to the computing device.
